(19) United States
(12) Patent Application Publication
(10) Pub. No.: US 2010/0256833 A1
(43) Pub. Date: Oct. 7, 2010

(54) METHOD AND PARAMETERISABLE DEVICE FOR DISTRIBUTING AND MANAGING POWER

(76) Inventor: David Luo, Nimes (FR)

Correspondence Address: LERNER GREENBERG STEMER LLP, P O BOX 2480, HOLLYWOOD, FL, 33022-2480, US

(21) Appl. No.: 12/599,150

(22) PCT Filed: May 13, 2008
(86) PCT No.: PCT/IB08/01176

§ 371 Date: Nov. 6, 2009

(30) Foreign Application Priority Data
May 10, 2007 (FR) 0703355
May 21, 2007 (FR) 0703584

(51) Int. Cl. G06F 1/26

(52) U.S. Cl. 700/297

(57) ABSTRACT

The invention relates to a power distribution and management device that comprises: at least one means (101) for connection to a power source; at least one power distribution point (1081) of said power source; a selection means (1061) capable of associating with at least one power distribution source a power distribution mode selected from at least two different distribution modes; and at least one modulation means (104) capable for each of at least one of said distribution modes, of controlling at least one physical characteristic of the source of the power distributed by each power distribution point associated with said power distribution mode.

This invention envisages a process and a device for parameterizable and controllable electricity distribution and management. It applies, in particular, to domestic or industrial electrical networks, and to the extension of these networks.

Every appliance requiring an electrical power supply is connected to an electrical network either directly or through an interface such as an electrical socket, for example by connecting to the two feeder lines and/or an optional neutral line of a single-phase network. The electricity is thus distributed from a source point, for example the power grid, to the connected appliances.

In general, a traditional network supplies electricity in a binary and uniform way to all the distribution points. That is to say that the network can supply or cut the electricity to all the connected appliances at the same time.

However, not all appliances operate in the same way. For example some appliances, such as a fax machine or a video cassette recorder, often need to be put on standby to remain available or for programmed recordings, whereas appliances like the television or scanner can be powered off completely when not being used.

The only way of powering these appliances off is to manually disconnect them each time. For example, for a domestic network, these appliances must be physically disconnected several times a day. Because of this complication, these appliances are not generally powered off completely, and they continue to consume electricity in standby mode, which is all the more detrimental when there are a large number of appliances.

The aim of the present invention is to remedy these drawbacks.

To this end, this invention envisages a device for distributing and managing electricity, which comprises:

at least one means of connecting to an electricity source,

at least one point distributing electricity from said electricity source, characterized in that it comprises, in addition:

a selection means designed to associate an electricity distribution mode, chosen from at least two different distribution modes, to at least one electricity distribution point and

at least one modulation means designed, for each of at least one of said distribution modes, to modulate at least one physical characteristic of the electricity source distributed by each electricity distribution point associated to said electricity distribution mode.

Thanks to these provisions, an electricity distribution point is configured according to the characteristics of the connected appliance. For example, where the distribution modes comprise a “non-standby” mode, that is to say the possibility of cutting off electricity completely for a distribution point. Each time an appliance is connected to a distribution point, you define at the same time whether it needs to be on standby or not. Thus, by means of a central command for a single network, you can easily cut the electricity off completely for all appliances except for those that need to be kept on standby.

Thanks to these provisions, an electricity distribution network can be configured dynamically by parameterizing the characteristic of each distribution point, based on the characteristic of the connected appliance.

It is noted that this invention can be applied to, but is not restricted to, an industrial network or a domestic network. It can be integrated as well in an extendable socket base to an existing network, for example a multi-socket.

According to particular features, the selection means is designed so that one of the distribution modes consists of permanently letting said electricity source pass.

According to particular features, the selection means is designed so that one of the distribution modes consists of an immediate or deferred activation or deactivation of the power supply for each associated distribution point.

Thanks to these provisions, an electricity distribution network can provide a significant number of modes at each distribution point. It becomes entirely parameterizable according to the user's requirements.

According to particular features, the selection means and the modulation means are powered by an independent electricity source.

According to particular features, the selection means and/or the modulation means comprise at least one contactor equipped with an interface with which a user can interact, said contactor being designed to provide a signal representative of a user's interaction on its interface. It can be located in a different geographical area to the other parts.

According to particular features, said modulation means comprises at least one detector or wireless contactor, designed to receive and interpret interactions or the presence of human beings.

According to particular features, said modulation means comprises at least one receiver, designed to receive and interpret a signal representative of a command sent by an independent device via a wireless network.

Thanks to these provisions, the user can easily modulate the whole network via several means: by an interaction on a contactor or a detector in the immediate vicinity, by an interaction on a remote control in close vicinity, and even when the user is not directly on the spot. For example, the user can use his/her mobile telephone to send a signal to switch on the heating when he/she leaves one location for another; Thus, the system interprets this signal and powers the distribution point on which the heating system is connected.

According to particular features, the distribution mode's selection means comprises at least one commutator comprising an interface with which a user can interact, located on a distribution point, said commutator being designed to parameterize the distribution mode according to the interaction between a user and its interface at the distribution point.

According to particular features, the modulation means comprises at least two parts:

an interface module, designed to provide a signal representative of a user's interaction with said interface module, and

a commutation module for each parameterizable distribution point, designed to modulate at least one physical characteristic of the source of electricity distributed by said electricity distribution point, according to the signal provided by the interface module.

Signals are transferred between the interface module and the commutation modules by wired or wireless transmissions.

Thanks to these provisions, the distribution network can be comprised of independent bases. For example, one base for the interface module, and bases of which each, connected to the source of electricity to be distributed, comprises at least one distribution point.

According to particular features, each commutation module comprises an emitter designed to re-emit the signal received from the interface module or another commutation module.

Thanks to these provisions, the signal from the interface module can be relayed over all the distribution points, especially when the base is a wireless base with a limited range, for example infrared.

According to particular features, each commutation module comprises at least one electronic, electrical or electro-mechanical switch, located on the corresponding distribution point and designed to interrupt or authorize the passage of the electricity to said distribution point, according to the signal from the interface module.

According to particular features, the modulation means comprises, in addition, a management module designed to assign a unique identifier to each distribution point, and to send a commutation command associated to at least one identifier of a single distribution mode to all the commutation modules.

According to particular features, the commutation module is designed in addition to store its distribution point's identifier and to recognize each command intended for it based on the recipient's identifier associated to said command.

Thanks to these provisions, the device offers a simple solution for managing a network with a significant number of distribution modes. In addition, it simplifies the cabling.

According to particular features, the selection means is designed to receive a signal from an appliance, when said appliance is connected to a distribution point or on request from the selection means, and to associate a distribution mode to the identifier of the distribution point to which the appliance is connected on the basis of said signal.

Said signal can be information concerning the appliance's characteristics or the pre-defined distribution mode.

Thanks to these provisions, the distribution point automatically selects the mode of the electricity to be distributed when an appliance is connected to it and is able to provide it with a meaningful signal.

According to particular features, the commutation module is designed to detect the presence of an appliance connected to an associated distribution point and to inform the selection module of this.

According to particular features, the selection module is designed to reset the distribution point to default mode if an appliance is disconnected.

Thanks to these provisions, the device offers a solution for handling the following situation: if a distribution point in dynamic mode is deactivated, when it is disconnected in order to connect a second appliance, since the appliance is not powered it cannot send information to the selection means for carrying out the parameterization.

According to particular features, the selection means and the modulation means comprise a system for checking the device's administration rights.

Thanks to these provisions, the device offers security to its entire network and its installations. It can be very useful for an industrial network.

According to particular features, each distribution point comprises as many connections as there are distribution modes. Thus, each connection represents a distribution mode, and is linked to the active lines of said electricity source, except for the neutral line.

According to the distribution mode selection, the distribution point is connected to one and only one corresponding connection.

Thanks to these provisions, the device is greatly simplified for a limited number of distribution modes.

According to a second aspect, this invention envisages a process for distributing and managing electricity, which comprises:

a step powering at least one distribution point for an electricity source,

a step parameterizing at least one distribution point making it possible to associate an electricity distribution mode, chosen from at least two different distribution modes, to each electricity distribution point and

a step modulating, for at least one of said distribution modes, at least one physical characteristic of the source of electricity distributed by each electricity distribution point associated to said electricity distribution mode.

According to a third aspect, this invention envisages a multi-socket that comprises a device as described in brief above.

As the advantages, aims and characteristics of this process and this multi-socket are similar to those of the distribution and management device, as described in brief above, they are not repeated here.

Other advantages, aims and characteristics of the present invention will become apparent from the description that will follow, made, as an example that is in no way limiting, with reference to the drawings included in an appendix, in which:

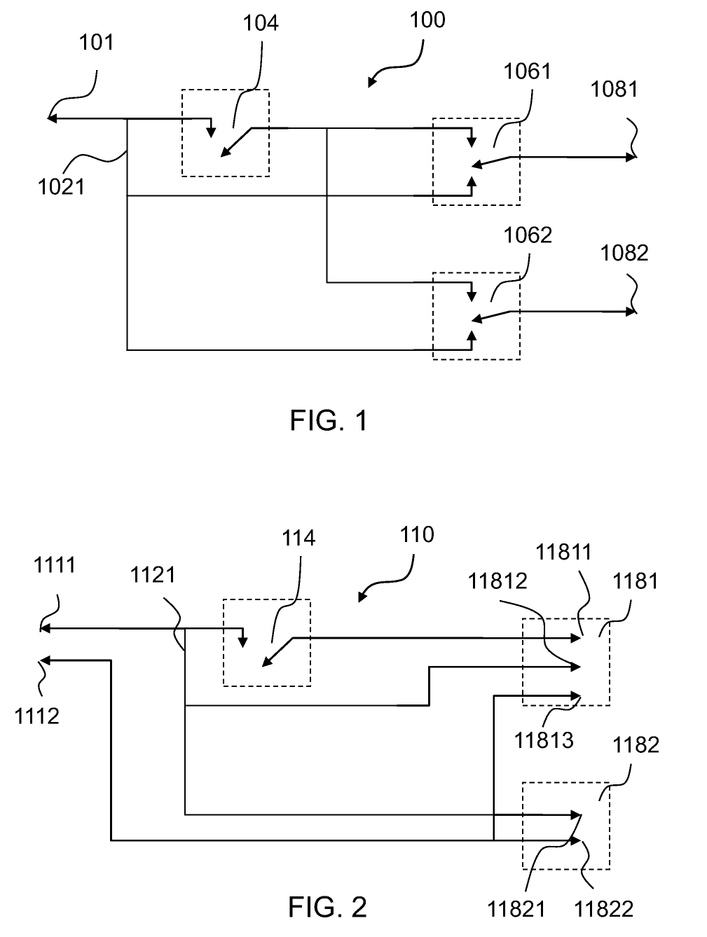

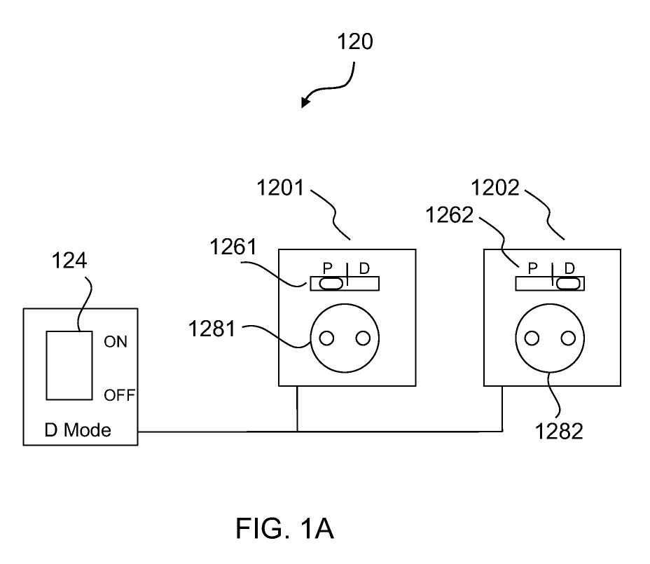

FIG. 1 represents, schematically, a first embodiment of a device of this invention;

FIG. 2 represents, schematically, a variant of the first embodiment;

FIG. 1a represents, schematically, a partial illustration of a domestic device, according to the first embodiment, where the distribution points are wall sockets.

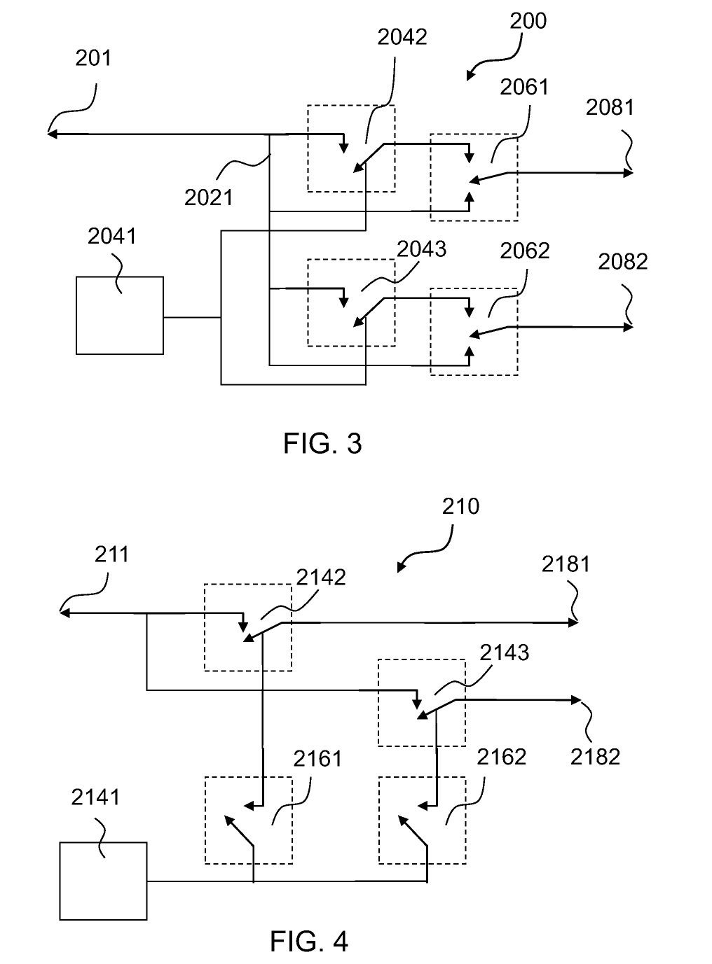

FIG. 3 represents, schematically, a second embodiment of a device of this invention;

FIG. 4 represents, schematically, a first variant of the second embodiment;

FIG. 5 represents, schematically, a second variant of the second embodiment;

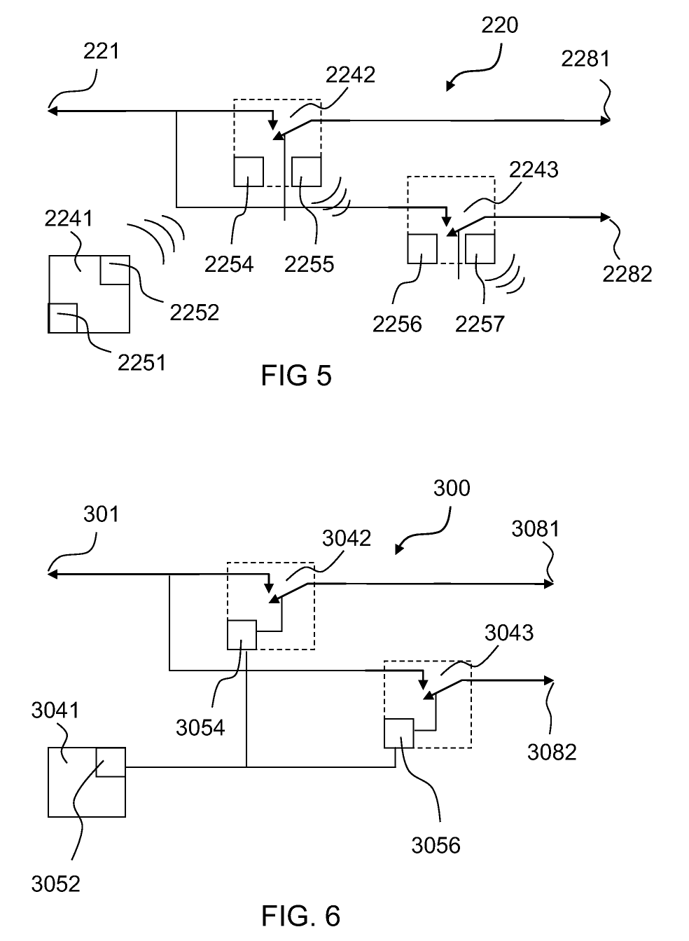

FIG. 6 represents, schematically, a third embodiment of a device of this invention and

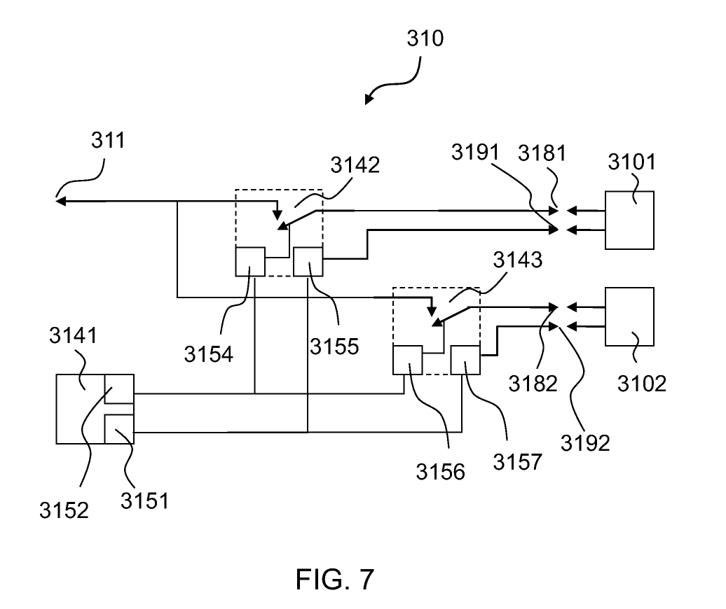

FIG. 7 represents, schematically, a variant of the third embodiment.

In a first embodiment, illustrated by FIG. 1, the electricity distribution device utilizes two distribution modes, one mode known as “permanent” and one mode known as “dynamic”. The permanent mode corresponds to a permanent power supply for distribution points. In contrast, the dynamic mode corresponds to an ad-hoc power supply to distribution points, where these latter can be powered or not according to a command from a user.

FIG. 1 shows a device 100 comprising a means of connection 101 to an electrical energy source, for example the power grid, and two distribution points 1081 and 1082, respectively linked to two selection means (two commutators) 1061 and 1062, each enabling one of the two distribution modes to be selected. The selection means 1061 and 1062 are connected to the electricity source either directly by path 1021 or via a modulation means (electrical commutator) 104. As a consequence, the selection means determines which path links the distribution points to the source.

When the user connects a first appliance utilizing a standby function to a distribution point 1081, the user activates the commutator to select the permanent distribution mode. Thus, the appliance is connected directly to the electricity source, via path 1021.

When the user connects a second appliance to a distribution point 1082 and the user does not want the standby function, the user activates the commutator to select the dynamic distribution mode. Thus, the appliance is connected to the electricity source via the modulation means 104.

By this means, when the user wants to cut all non-necessary power supplies, for example when he/she leaves a location, he/she only needs to place commutator 104 in the open position, which cuts the second appliance's power supply while maintaining the power supply to the first appliance. When he/she wants to power it again, he/she only needs to place commutator 104 in the closed position.

Thus, thanks to the utilization of this invention, by modulating a characteristic of the electricity source, in this case authorizing or prohibiting its passage, you cut the power supply to or power up distribution points in dynamic mode, as well as the appliances connected to these distribution points, while maintaining a permanent power supply to other distribution points in the network.

In a variant of the first embodiment, shown in FIG. 2, the device 110 comprises a parameterizable distribution point 1181, equipped with two connections 11811 and 11812 each of which corresponds to a distribution mode, offering a means of selecting the distribution mode, and another non-parameterizable distribution point 1182, with no selection means. Connection 11811 is connected to the electricity source via a modulation means (electrical commutator) 114; and connections 11812 and 11821 are connected directly to the electricity source via path 1121. In this variant, the electricity source comprises a neutral or ground phase, which is directly connected to connections 11813 and 11822 of distribution points 1181 and 1182 respectively. In this way, the number of the device's lines is reduced.

Thus, thanks to the utilization of this invention, the user has several connections on one distribution point. The user selects a distribution mode by connecting an appliance directly to the connection corresponding to the distribution mode selected.

FIG. 1a partially illustrates a domestic electricity distribution device comprising wall sockets, having both “permanent” and “dynamic” distribution modes, according to the first embodiment.

FIG. 1a shows a device 120 comprising a means of connecting to a source of electrical energy, a wall flip-flop switch 124 and two wall blocks 1201 and 1202, each comprising a wall socket, 1281 and 1282 respectively, and each a sliding commutator, 1261 and 1262 respectively. Commutators 1261 and 1262 enable, for wall sockets 1281 and 1282 respectively, one of the two distribution modes to be selected. Switch 124 enables the connection between the energy source and the wall sockets with “dynamic” distribution mode to be interrupted (OFF position) and established (ON position).

When the user connects a first appliance utilizing a “standby” function to wall socket 1281, the user places the sliding switch 1261 on the position marked “P”.

When the user connects a second appliance to wall socket 1282 and the user does not want the standby function, the user places the sliding switch 1261 on the position marked “D”.

By this means, when the user wants to cut all non-necessary power supplies, for example when he/she leaves a location, he/she only needs to place switch 124, located for example close to the out port, in the OFF position, which cuts the second appliance's power supply while maintaining the power supply to the first appliance. When he/she wants to power it again, he/she only needs to place commutator 124 in the ON position.

In a second embodiment, illustrated in FIG. 3, the electricity distribution device 200 also utilizes the two distribution modes, permanent and dynamic. Each modulation means comprises at least two modules, an interface module and a commutation module.

FIG. 3 shows the device 200 which comprises a means of connection 201 to an electrical source and two distribution points 2081 and 2082, respectively linked to two selection means (two commutators) 2061 and 2062 utilizing two distribution modes, each of which is connected to the electricity source either directly by path 2021 or via a commutation module (electrical commutator), 2042 and 2043 respectively. A common interface module (commutator) 2041 allows a signal to be sent to all the commutation modules 2042 and 2043 that is representative of a user's interaction on its interface.

As in the first embodiment, in this second embodiment the user selects a distribution mode for each appliance connected. When he/she wants to cut all non-necessary power supplies, for example when he/she leaves a location, the common interface module receiving the user's request to deactivate the power supply sends a representative signal to all commutation modules 2042 and 2043, which will responsible for cutting power to all distribution points in dynamic mode. The means of communication between the various means and/or modules are detailed, as an example, in the variants of the second embodiment described below. When he/she wants to power it again, he/she only needs to issue the command to activate the power supply.

In a variant of the second embodiment, illustrated in FIG. 4, a device 210 comprises a means of connection 211 to an electrical source and two distribution points 2181 and 2182. These points are connected to the electrical source via commutation modules (commutators) 2142 and 2143 respectively. By default these modules are passing modules and therefore allow the electricity to pass to the distribution points. A common interface module (commutator) 2041 allows a signal to be sent to the two selection modules (commutators) 2061 and 2062 that is representative of a user's interaction on its interface. Depending on the distribution mode, these two selection modules 2061 and 2062 route or do not route the signal to the distribution points' commutation modules.

By default, the device is in permanent mode. Therefore the distribution points are linked to the electricity source. The selection means does not route the interface module's signal to the commutation module. In contrast, when a dynamic mode is selected by the user, the selection means transmits the interface module's signal to the corresponding commutation module. The distribution point is therefore controlled by the common interface module.

In variants of the second embodiment, illustrated in FIGS. 3 and 4, the interface module is powered directly by the electricity source. In other variants, the interface module is powered by another source, for example a battery.

In a variant of the second embodiment, illustrated in FIGS. 3 and 4, the signal sent by the interface module is directly carried by the electricity signal, based on power-line carrier techniques, via, for example, amplitude modulation; the commutation module comprises, in addition, a modulation detector able to interpret the modulated signal. The selection means consists of activating or deactivating the modulation detector.

In a variant of the second embodiment, illustrated in FIG. 5, the signal is sent by the interface module 2241 over a wireless medium, for example infrared or radio wave, via a radio emitter 2252. In the same way, each commutation module 2242, 2243 respectively, comprises a receiver 2254, 2256 respectively, of the same type able to receive and interpret the signal sent.

For example, in this variant of the second embodiment, illustrated in FIG. 5, each commutation module (commutator) 2242, 2243 respectively, comprises a radio receiver 2254, 2256 respectively, able to receive the radio signal initially sent by the common interface module 2241 and a radio emitter 2255, 2257 respectively, able to send the same radio signal to other nearby commutation modules.

Thus, the interface module is a module independent of the distribution device, for example a remote control. This simplifies in particular the installation of such a device. For example, to install such a device in an existing domestic network, you only need to replace the standard wall sockets by the parameterizable distribution points of such a device, in the form of wall sockets, without needing to rewire the entire network. The device is controlled by means of a dedicated remote control or a remote control converted to this function.

In this variant of the second embodiment, illustrated in FIG. 5, the interface module 2241 comprises, in addition, a receiver 2251 designed to receive and interpret a signal representative of a command sent by an independent device, for example a mobile telephone or a computer terminal, via a fixed or wireless data network.

Thus in order, for example, to remotely command the activation of a heating system before arriving on the spot, the user uses his/her mobile phone to send a signal or a message representative of the heating activation request to the corresponding interface module. After receiving, checking and interpreting the signal, this interface module sends an activation command to all distribution points, on which the heating management systems are connected, associated to this distribution mode. The management system activates the heating.

In a third embodiment, illustrated by FIG. 6, each distribution point has a unique identifier. The modulation means comprises at least two parts, a management module and a commutation module. The management module handles selecting the distribution modes of the distribution points in a centralized way and sending a command associated to the recipients' identifiers to all commutation modules, on request from the user. Only the modules corresponding to the identifiers process the command.

FIG. 6 shows a device 300 comprising a means of connection 301 to an electrical source and two distribution points 3081 and 3082. These points are connected to said electrical source via two commutation modules (commutators), 3042 and 3043 respectively. A management module 3041 is designed to assign a unique identifier to each distribution point, to associate a distribution mode to the identifiers and to interpret a command signal representative of human interactions. In addition, the management module 3041 is designed to send a signal representative of an identifier or a commutation request associated to at least one identifier, via its emitter 3052, to their commutation module 3042 and 3043. The commutation modules 3042 and 3043 respectively comprise receivers 3054 and 3056 designed to store the identifiers and to recognize if a command is intended for them and, if it is, to process it.

Thus, when the device is powered up, the management module assigns an identifier to each commutation module, which stores it in memory. For each appliance connected to a distribution point, the user associates to it a distribution mode with the distribution point identifier, according to the characteristics of the appliance, thanks to the management module's interface. The management module automatically groups the identifiers associated to the same distribution mode, for example dynamic mode. Before leaving a location, the user initiates a command via the management module interface, which sends a signal representative of this command with all the associated recipient identifiers to all the commutation modules. The recipients recognize themselves and execute the command in question.

In this way the parameterization of the distribution points is centralized in the management module.

In a variant of the third embodiment, illustrated in FIG. 6, communications between the emitter 2252 and the receivers 3054 and 3056 are wireless communications.

In a variant of the third embodiment, illustrated in FIG. 6, the management module is designed to restrict the parameterization and modulation of distribution points solely to administrators having these rights.

In this way, the device offers security to its entire network and its installations, which can be very useful for an industrial network.

In a variant of the third embodiment, illustrated in FIG. 7, the characteristics of appliances are communicated to the management module when connecting to the distribution point.

FIG. 7 shows a device 310 comprising a means of connection 311 to an electrical source, two distribution points 3181 and 3182 and two information points 3191 and 3292. A management module 3141 is designed to assign a unique identifier to each distribution point. The distribution points are connected to said source via two commutation modules (commutators), 3142 and 3143 respectively. These modules respectively comprise a relay module 3155 and 3157, designed to receive the information signals sent by appliances 3101 and 3102 respectively via information points 3155 and 3157, and to send all or part of the information to the management module's receiver 3151 with the distribution point's identifier. The management module 3141 is designed to receive and process this information and to associate a distribution mode to this identifier, and thus to the distribution point. In addition, the management module 3141 is designed to send a signal representative of human interactions on its interface, associated to at least one identifier, to commutation modules 3142 and 3143, via its emitter 3152. Modules 3142 and 3143 respectively comprise receivers 3154 and 3156 and are designed to store the identifiers, to recognize if a command is intended for them and, if it is, to process it.

In this way, the parameterization of distribution modes is completely automatic. In effect, when an appliance is connected to a distribution point, the management module receives this appliance's characteristics and the distribution point's identifier, and automatically associates a distribution mode to this identifier. The management module can also group it with other identifiers of distribution points associated to the same distribution mode.

In this variant of the third embodiment, illustrated in FIG. 7, the commutation module is designed to detect the presence of an appliance connected to the associated distribution point and to inform the management module of this. The management module resets the distribution point to default mode if an appliance is disconnected.

Throughout the description, an electricity source is defined as a source able to deliver a flow of electrical energy, in all forms. It can be direct or alternating, single-phase or three-phase, and it can have a neutral line or not.

Throughout the description, two distribution modes are described, a permanent mode and a dynamic mode. However, this invention is not restricted to these two distribution modes. For example, this invention can be extended to a deferred mode, in which the command is executed after a defined period of time.

Throughout the description, the modulation means that is designed to let pass or cut the flow of power from the source to the distribution points is described, as an example. However, the modulation means is not restricted to these functions and is designed to modulate all the characteristics of the electricity source. For example, a modulation of the energy flow voltage.

Throughout the description, the modulation means or interface module comprising an electrical commutator, designed to provide a signal representative of a user's interaction on its interface, is described, as an example. However, this invention can comprise several commutators, spread over different geographical areas, each of which is designed to provide a representative signal.

Throughout the description, an electrical commutator performing an electrical commutation when the user interacts with said commutator is described, as an example. However, this invention can be utilized with all types of commutators, for example mechanical or electrical commutators, remote control switches, tactile or non-tactile membrane commutators, commutators utilizing optical commutations, variations in impedance, capacitance for example, Reed, PushGate, Piezoelectric and Hall effect contactors, contactless detection commutators, remotely controlled by radio waves.

Throughout the description, a switch is defined as a special commutator performing an electrical outage when the user interacts with said switch.

Throughout the description, some links are described that are wired and some links are described that are wireless, as an example. However, this invention can be utilized for all links, wired and/or wireless.

1-20. (canceled)

21. An electrical distribution device connected or connectible to a domestic or industrial electrical network, comprising:
a plurality of electricity distribution points;
at least one selection device configured to link a respective said electricity distribution point to the electrical network according to at least two distribution modes; and
at least one commutation device configured to, in a given distribution mode, activate or deactivate, in an immediate way or a deferred way, the power supply of a plurality of respective said distribution points associated therewith.

22. The device according to claim 21, wherein, in another distribution mode, said electricity distribution point is permanently linked to the electrical network.

23. The device according to claim 21, wherein, in another distribution mode, the respective said distribution point is linked to a commutation means that activates or deactivates in an immediate or deferred way the power supply for each associated said distribution point.

24. The device according to claim 21, which comprises an independent electricity source connected to power said selection device and said commutation device.

25. The device according to claim 21, wherein said selection device and said commutation device each comprise at least one contactor equipped with an interface for interaction by a user, said contactor being designed to provide a signal representative of a user's interaction on said interface.

26. The device according to claim 21, wherein said commutation device comprises at least one detector or wireless contactor, configured to receive and interpret interactions or a presence of human beings.

27. The device according to claim 21, wherein said commutation device comprises at least one receiver designed to receive and interpret a signal representative of a command sent by an independent device via a wireless network.

28. The device according to claim 21, wherein said selection device for selecting the distribution mode comprises at least one commutator comprising an interface for interaction with a user, located on a distribution point, and wherein said commutator is configured to parameterize the distribution mode according to the interaction between a user and said interface at the distribution point.

29. The device according to claim 28, wherein said commutation device comprises at least two parts, including:
an interface module, configured to provide a signal representative of a user's interaction with said interface module; and
a commutation module for each parameterizable distribution point, configured to modulate at least one physical characteristic of the source of electricity distributed by said electricity distribution point, according to a signal provided by the interface module.

30. The device according to claim 29, wherein each commutation module comprises an emitter designed to re-emit the signal received from said interface module or another commutation module.

31. The device according to claim 29, wherein each said commutation module comprises at least one electronic, electrical or electro-mechanical switch, disposed at the corresponding said distribution point and configured to interrupt or authorize a passage of electricity to said distribution point, according to a signal from said interface module.

32. The device according to claim 29, wherein said commutation device further comprises a management module configured to assign a unique identifier to each distribution point, and to send a commutation command associated with at least one identifier of a single distribution mode to all said commutation modules.

33. The device according to claim 29, wherein said commutation module is configured to store a respective identifier of a distribution point and to recognize each command intended for it based on a recipient identifier associated to said command.

34. The device according to claim 32, wherein said selection device is configured to receive a signal from an appliance, when said appliance is connected to a distribution point, when an appliance's characteristic changes or on request from said selection device, and to associate a distribution mode with the identifier of the distribution point to which the appliance is connected on the basis of said signal.

35. The device according to claim 31, wherein said commutation module is configured to detect a presence of an appliance connected to an associated distribution point and to inform said selection module thereof.

36. The device according to claim 29, wherein said selection module is configured to reset the distribution point to a default mode if an appliance is disconnected.

37. The device according to claim 21, wherein said selection device and said commutation device include a system for checking administration rights associated with the device.

38. The device according to claim 21, wherein each distribution point includes a number of connections equal to a number of distribution modes.

39. A method of distributing and managing electrical power, which comprises:
energizing at least one distribution point for an electricity source;
parameterizing at least one distribution point rendering it possible to associate with each electricity distribution point an electricity distribution mode, chosen from at least two different distribution modes, with at least one where the electricity distribution point is linked to a commutation means that activates or deactivates in an immediate or deferred way the power supply for various associated distribution point associated therewith; and
commutating the commutation means.

40. A multi-socket device, comprising the device according to claim 21.
